(19) United States
(12) Patent Application Publication
(10) Pub. No.: US 2018/0358021 A1
(43) Pub. Date: Dec. 13, 2018

(54) BIOMETRIC INFORMATION FOR DIALOG SYSTEM

(71) Applicant: Intel Corporation, Santa Clara, CA (US)

(72) Inventors: Meladel Mistica, Sunnyvale, CA (US); Martin Henk Van Den Berg, Palo Alto, CA (US); Guillermo Perez, Sevilla (ES); Robert Jim Firby, San Mateo, CA (US); Beth Ann Hockey, Sunnyvale, CA (US)

(73) Assignee: Intel Corporation, Santa Clara, CA (US)

(21) Appl. No.: 15/781,229

(22) PCT Filed: Dec. 23, 2015
(86) PCT No.: PCT/EP2015/081218

§ 371 Date: Jun. 4, 2018

(51) Int. Cl. G10L 17/04; G10L 15/26; G10L 15/22

(52) U.S. Cl. CPC G10L 17/04; G10L 2015/225; G10L 15/22; G10L 15/26

(57) ABSTRACT

The present disclosure describes providing a biometric signal as an input to a dialog system. A biometric signal processor can derive contextual biometric information about the biometric signal based on stored information and received, user-provided information. The dialog system can be used to interface with a user to receive contextual data about the user's status or activities, and can be used to interact with the user to request information and provide the contextualized biometric information.

### TECHNICAL FIELD

This disclosure pertains to providing biometric information as an input to a dialog system.

### BACKGROUND

Fitness applications and devices are growing in popularity as consumer devices. Fitness applications and devices can record biometric data of different kinds and have a corresponding application on a mobile device or computer to interact with the data. These interactions involve looking at the screen, necessarily interrupting the user.

### BRIEF DESCRIPTION OF THE DRAWINGS

FIG. 1 is a schematic block diagram of a system that includes a dialog system that uses biometric input in accordance with embodiments of the present disclosure.

FIG. 2 is a schematic block diagram of a biometric input processing system in accordance with embodiments of the present disclosure.

FIG. 3 is a schematic block diagram of a dialog system that uses input from a biometric input processor in accordance with embodiments of the present disclosure.

FIG. 4 is a process flow diagram for selecting a linguistic model for automatic speech recognition in accordance with embodiments of the present disclosure.

FIG. 5 is a process flow diagram for selecting a linguistic model for automatic speech recognition based on a heartrate input in accordance with embodiments of the present disclosure.

FIG. 6 is an example illustration of a processor according to an embodiment of the present disclosure.

FIG. 7 is a schematic block diagram of a mobile device in accordance with embodiments of the present disclosure.

FIG. 8 is a schematic block diagram of a computing system according to an embodiment of the present disclosure.

### DETAILED DESCRIPTION

This disclosure describes augmenting applications controlling fitness devices with a dialog interface. Such a dialog system could answer questions about the metrics, including answering questions about what the readings mean.

This disclosure describes using biometric information as an input to a dialog engine, as well as other contextual cues. The dialog interaction can include a query to the biometric data and user-provided input to discuss with the user or others, in a natural way, the meaning of the biometric sensor results. The biometric data and user-provided input can create contextual history and connect a relationship between different sensors. The system can also initiate a dialog when the sensor appears to have atypical or otherwise aberrant readings.

The result is an enhanced user experience with a fitness device or application that uses a biometric sensor to provide biometric information to a wearer or user. The wearer or user of the biometric sensor can get a better understanding of what the raw biometric information means.

As an example, in some embodiments, when a fitness device or application is being used, a user may want to track heart rate. The heart rate information can be provided to a biometric input processor to derive meaning from the heart rate beyond mere beats per minute. The biometric input processor can consult user-provided biometric information, such as age, weight, resting heart rate, fitness goals, etc. The biometric input processor can also consult user-provided inputs, such as current location and activity, via the dialog system. The biometric input processor can then derive meaning for the heart rate received from the biometric sensor. The heart rate may be too high or too low for user fitness goals or for the users age and/or weight, etc. The dialog system can establish a dialog with the user about maintaining, reducing, or increasing the heart rate based on the biometric information and on contextual data.

Example contextual data include user data (demographic, gender, acoustic properties of the voice such as pitch range), environmental factors (noise level, GPS location), communication success as measured based on dialog system performance/user experience given certain models. Additionally, contextual data can include data supplied by the user during previous dialog sessions, or from other interactions with the device. For example, if the user states that he/she is feeling tired or dehydrated, then the dialog system can adjust a heart rate threshold before the dialog system signals the user about heart rate information.

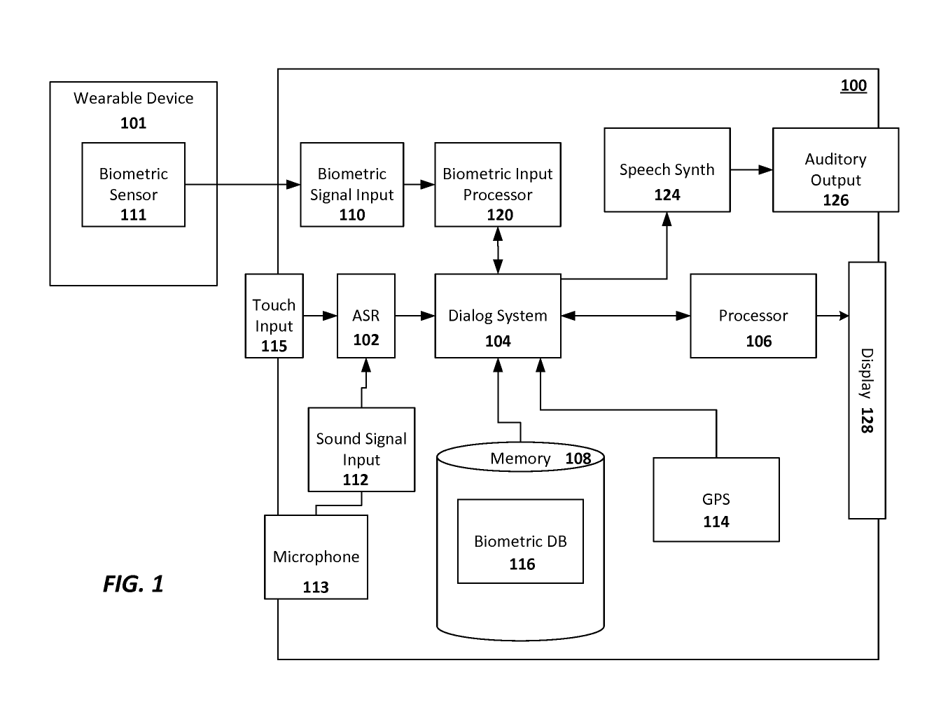

FIG. 1 is a schematic block diagram of a system 100 that includes a dialog system that uses biometric input in accordance with embodiments of the present disclosure. The system 100 may include a biometric sensor 111 that can provide a biometric signal into a biometric signal input 110. The biometric sensor 111 can be part of the system 100 or can be part of a separate device, such as a wearable device 101. The biometric sensor 111 can communicate with the system 100 via Bluetooth, Wifi, wireline, WLAN, etc. Though shown as a single biometric sensor 111, more than one biometric sensor can supply biometric signals to the biometric signal input 110.

The biometric signal input 110 can send a signal representative of a biometric signal to a biometric input processor 120 implemented in hardware, software, or a combination of hardware and software. The biometric input processor 120 can communicate information with a dialog system 104. For example, the biometric input processor 120 can receive user-provided information from the dialog system 104 to process biometric information. The biometric input processor 120 can also provide processed biometric information to the dialog system 104 to output a dialog to the user about the processed biometric information, such as context, meaning, or instructions.

The system 100 includes an automatic speech recognition (ASR) module 102 that can be implemented in hardware, software, or a combination of hardware and software. The ASR module 102 can be communicably coupled to and receive input from a sound input 112. The ASR module 102 can output recognized text to a dialog system 104.

Generally, the dialog system 104 can receive textual inputs from the ASR module 102 to interpret the speech input and provide an appropriate response, in the form of an executed command, a verbal response (oral or textual), or some combination of the two. The system 100 also includes a processor 106 for executing instructions from the dialog system 104. The system 100 can also include a speech synthesizer 124 that can synthesize a voice output from the textual speech. System 100 can include an auditory output 126 that outputs audible sounds, including synthesized voice sounds, via a speaker or headphones or Bluetooth connected device, etc. The system 100 also includes a display 128 that can display textual information and images as part of a dialog, as a response to an instruction or inquiry, or for other reasons.

In some embodiments, system 100 also includes a GPS system 114 configured to provide location information to system 100. In some embodiments, the GPS system 114 can input location information into the dialog system 104 so that the dialog system 104 can use the location information for contextual interpretation of speech text received from the ASR module 102.

The biometric sensor 111 can include any type of sensor that can receive a biometric signal from a user (such as a heart rate) and convert that signal into an electronic signal (such as an electrical signal that carries information representing a heart rate). An example of a biometric sensor 111 includes a heart rate sensor. Another example is a pulse oximeter, EEG, sweat sensor, breath rate sensor, pedometer, etc. In some embodiments, the biometric sensor 111 can include an inertial sensor to detect vibrations of the user, such as whether the users hands are shaking, etc. The biometric sensor 111 can convert biometric signals into corresponding electrical signals and input the biometric electrical signals to the ASR module 102 via a biometric input signal input 110 and biometric input processor 120.

Other examples of biometric information can include heart rate, stride rate, cadence, breath rate, vocal fry, breathy phonation, amount of sweat, EEG data, temperature, etc.

The system 100 can also include a microphone 113 for converting audible sound into corresponding electrical sound signals. The sound signals are provided to the ASR module 102 via a sound signal input 112. Similarly, the system 100 can include a touch input 115, such as a touch screen or keyboard. The input from the touch input 115 can also be provided to the ASR module 102.

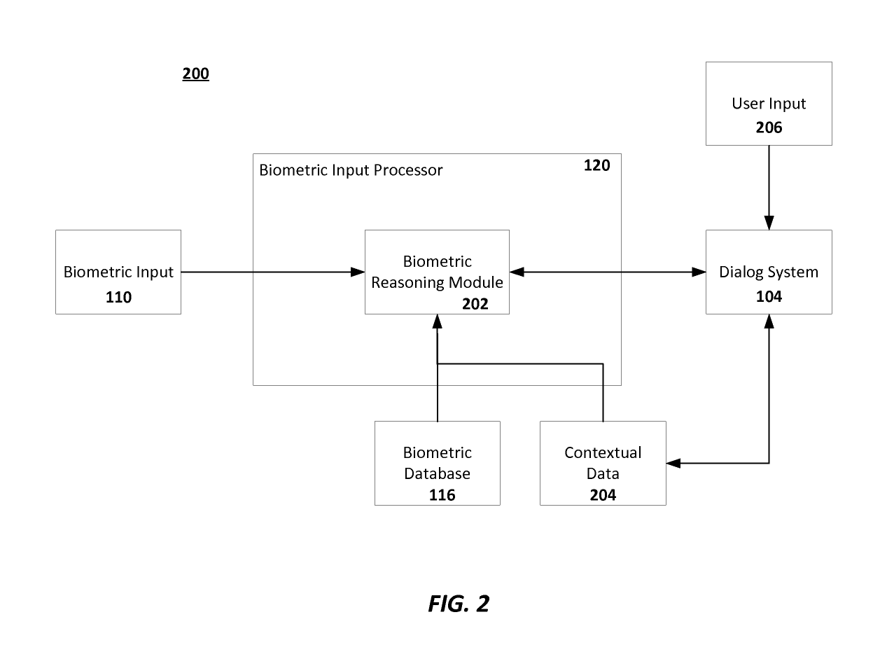

FIG. 2 is a schematic block diagram 200 of a biometric input processor 120 in accordance with embodiments of the present disclosure. The biometric input processor 120 can be a stand-alone device, a part of a wearable unit, or part of a larger system. The biometric input processor 120 can be implemented hardware, software, or a combination of hardware and software.

The biometric input processor 120 can include a biometric reasoning module 202 implemented in hardware, software, or a combination of hardware and software. The biometric reasoning module 202 can receive an electrical signal representing a biometric signal from a biometric input 110 (which is communicably coupled to a biometric sensor, as shown in FIG. 1).

The biometric reasoning module 202 can process the signal from the biometric input 110 to derive a context for or meaning of the biometric signal. The biometric reasoning module 202 can use stored contextual data 204 to derive context or meaning for the biometric signal. Additionally, the biometric reasoning module 202 can request additional contextual data from the user to derive context or meaning of the biometric signal, and store that user-provided contextual data in the memory 108. A biometric database 116 can include user-provided biometric information, such as resting heart rate, age, weight, height, blood pressure, fitness goals, stride length, body mass index, etc. Additionally, biometric database can include “norms” for the general population as well as for people having similar physical characteristics as the user (e.g., by fetching that information from the Internet or other sources). For example, a target heart rate can be stored for reaching weight loss zone, fat burning zone, cardiovascular zone, etc. that correspond to various ages, weights, etc., and/or for people with similar physical characteristics as the user.

The biometric reasoning module 202 can extract information about the received biometric signal. For example, the biometric reasoning module 202 can determine what type of biometric information the signal conveys and a value associated with the biometric signal. For example, the biometric signal can include type: heart rate and value: 80 beats/minute. In some cases, the biometric signal can also include metadata associated with the source of the sensor signal, which can help the biometric reasoning module 202 derive context for the signal. For example, if the sensor signal is coming from a wearable sports band, then the biometric reasoning module 202 can narrow down contextual data to a subset of categories (e.g., exercise, excitement, fear, health risk, etc.). Additionally, multiple sensor signals can be received, such as heart rate and strides per minute, and the biometric reasoning module 202 can fuse sensor signal data to increase the accuracy of the conclusions drawn by the biometric reasoning module 202 (e.g., high heart rate and high strides per minute compared with baseline data can imply that the wearer is running).

The biometric reasoning module 202 can use stored context data to derive meaning from the biometric signal. For example, if the biometric signal includes a heart rate, then the biometric reasoning module 202 can identify contextual data that pertains to heart rate, such as exercise profiles (cardio zone, weight loss zone, etc.), target heart rates, maximum heart rates for the user's age, etc. The biometric reasoning module 202 can also use contextual data about the user, such as the user's age, weight, workout goals, location (from GPS information or from a calendar), current activity (such as running, bicycling, etc.).

The biometric reasoning module 202 can then derive meaning from the received sensor signal. For example, if the biometric sensor receives a heart rate of 90 beats/min., the biometric reasoning module 202 can 1) determine that the sensor signal includes heart rate information and identify contextual data associated with heart rate information, and 2) use the sensor value of 90 beats/min to determine that the user is jogging. The biometric reasoning module 202 can also infer other meaning from the sensor signal beyond what the user is doing, such whether the user is reaching target heart rates or whether the heart rate is too high. The biometric reasoning module 202 can send derived information to the dialog system 104, which can interact with the user to, for example, provide feedback to the user about whether the user is reaching the heart goals or whether the user needs to slow down because his or her heart rate is too high.

The biometric reasoning module 202 can also use contextual data 204 that may be provided by a user from previous dialogs, prior application usage, GPS positions, information pertaining to work-out goals, etc. Contextual data 204 can be updated based on information received by a dialog via dialog system 104.

The biometric reasoning module 202 can also communicate with the dialog system 104. The dialog system 104 can receive a request for more information from the biometric reasoning module 202, which the dialog system 104 can use to request further information from the user. For example, the dialog system 104 can request information about what the user is doing, where the user is, how the user is feeling, etc. The user can respond and the dialog system 104 can provide that information to the biometric reasoning module 202 and to the contextual data store 204.

In some embodiments, the user can request feedback through the dialog system 104. The biometric reasoning module 202 can process stored biometric sensor signals received over time to provide the user feedback using the aforementioned analysis. The dialog system 104 can also start a dialog without an explicit user request for feedback. For example, the biometric reasoning module 202 can determine that a heart rate is too high for a user (e.g., based on the age, weight, other health information, etc.) and provide feedback to the user to slow down to reduce the heart rate.

In some embodiments, the user can request feedback based on biometric triggers. For example, the user can configure the dialog system 104 to provide an alert when the user's heart rate reaches a certain level. The feedback can be configured specifically for the type of activity that the user is doing. For example, when the heart rate reaches a certain level for cardio zone, the dialog system 104 can tell the user that he/she has reached the cardio zone and to maintain that heart rate.

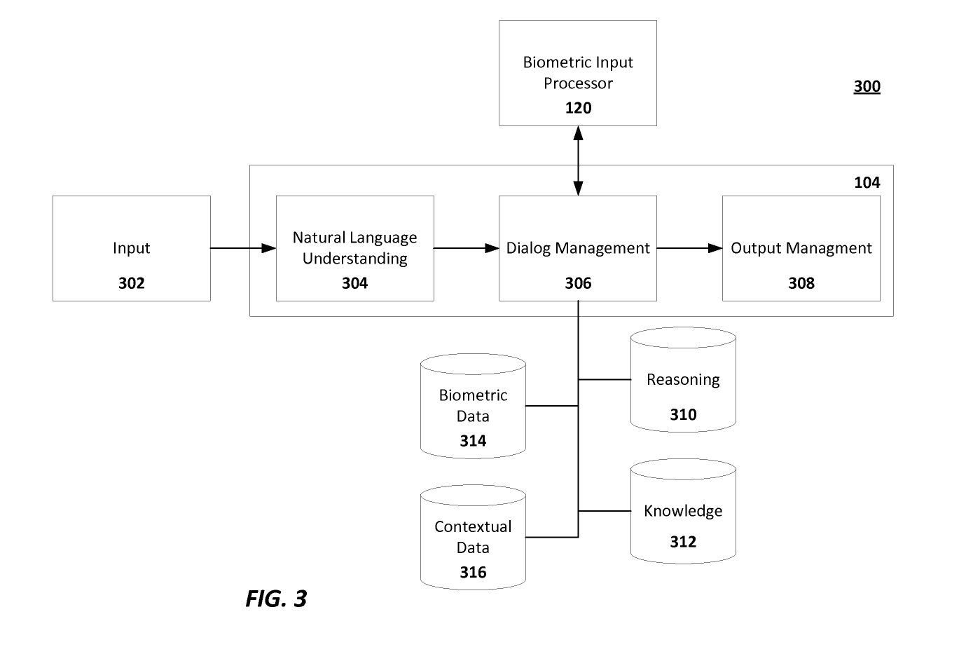

FIG. 3 is a schematic block diagram 300 of a dialog system 104 that uses input from a biometric input processor 120 in accordance with embodiments of the present disclosure. The dialog system 104 can receive an input 302 from the user. The input 302 can be a text input or speech input. The dialog system 104 can include a natural language understanding module (NLU) 304. NLU 304 uses libraries, parsers, interpreter modules, etc. to make a best interpretation of combined inputs. The NLU 304 also resolves underspecified material, e.g. “it,” “him,” “the last one.” The NLU 304 can provide an input to the dialog management module 306. The dialog management module 306 decides what to do in the conversation based on what was understood from the input 302 to the NLU 304. The dialog management module 306 can speak information, ask for clarification, display information, execute an action, etc.

The dialog management module 306 can also receive information from the biometric input processor 120 and to provide information to the dialog management module 306. The dialog management module 306 can access stored information such as biometric data 314, contextual data 316, general knowledge 312. The dialog management module 306 can also access a reasoning engine 310 that helps determine what is meant by indefinite requests that may require more context. The output management module 308 executes on how to do whatever the dialog management module 306 determines.

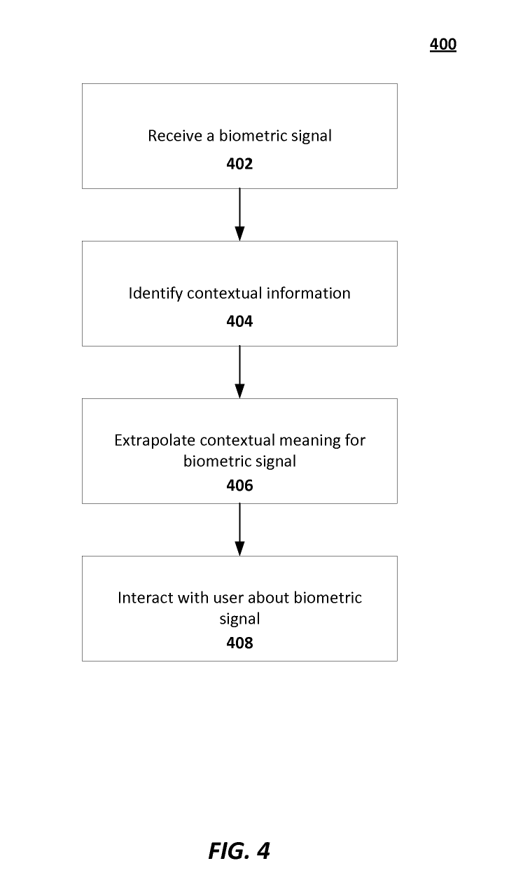

FIG. 4 is a process flow diagram 400 for using biometric information in a dialog system. A biometric signal (or more than one biometric signals) can be received by a device that includes a dialog system (402). Contextual data can be identified associated with the received biometric information and/or for the user (e.g., wearer of a biometric sensor) (404). In some embodiments, the dialog system can request information from the user/wearer for additional contextual data.

A biometric signal processor can process the biometric information and the contextual information to extrapolate meaning and context for the biometric signal (406).

The biometric signal processor can also identify a next action for the user device based on the biometric signal. The dialog system can interact with the user to relay messages, ask questions, provide instructions, and/or provide meaning about the biometric information, etc. (408).

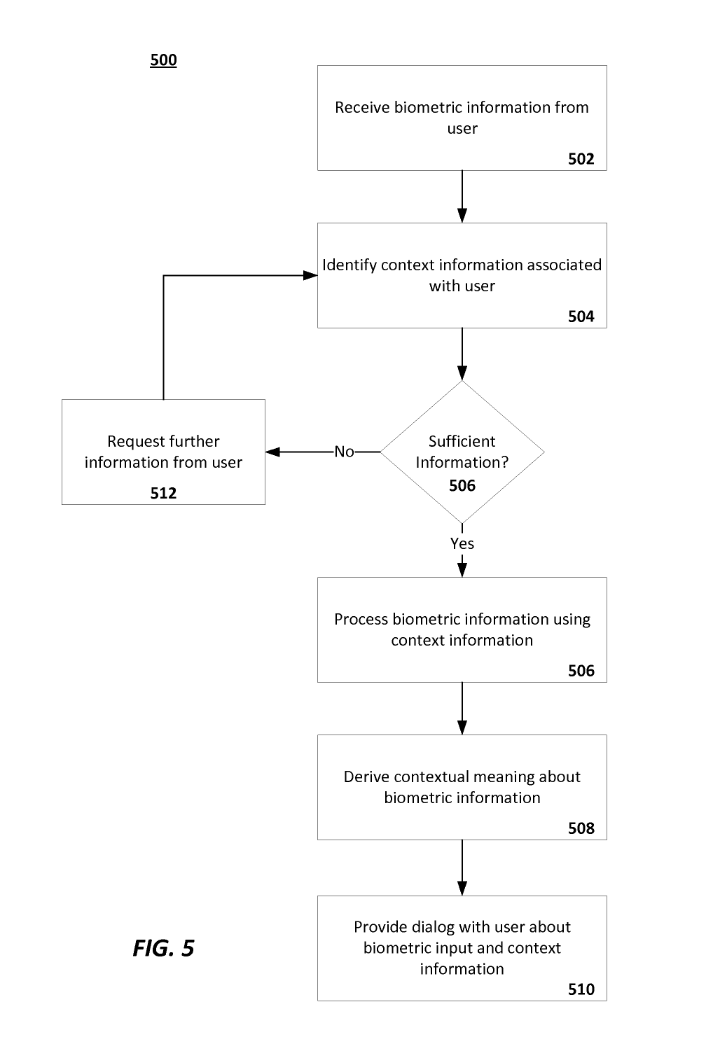

FIG. 5 is a process flow diagram for using biometric information in a dialog system in accordance with embodiments of the present disclosure. A biometric signal (or more than one biometric signals) can be received by a device that includes a dialog system (502). Contextual data can be identified for the biometric signal and/or the user (e.g., wearer of a biometric sensor) (504). The device can determine whether there is sufficient information to derive context for the user and the biometric signal (506). If the device requires more information to process the biometric signal, in some embodiments, the dialog system can request information from the user/wearer for additional context information (512). If the device has sufficient contextual data, a biometric signal processor can process the biometric information and the contextual data (506). Meaning and context for the biometric signal can be extrapolated (508). The biometric signal processor can also identify a next action for the user device based on the biometric signal. The dialog system can interact with the user to relay messages, ask questions, provide instructions, provide meaning about the biometric information, etc. (510).

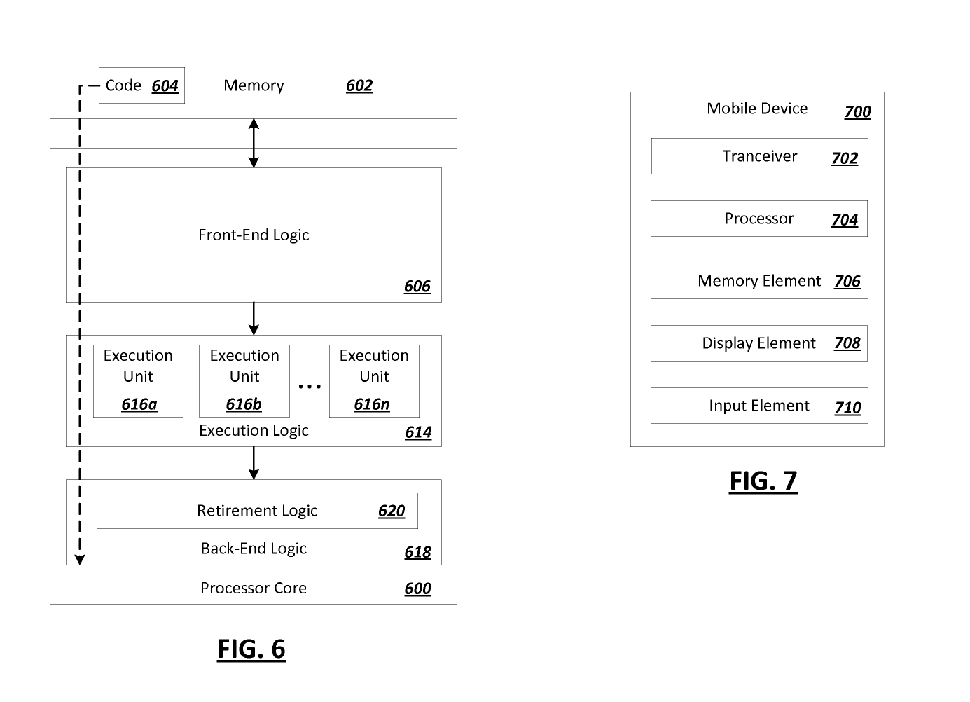

FIGS. 6-8 are block diagrams of exemplary computer architectures that may be used in accordance with embodiments disclosed herein. Other computer architecture designs known in the art for processors, mobile devices, and computing systems may also be used. Generally, suitable computer architectures for embodiments disclosed herein can include, but are not limited to, configurations illustrated in FIGS. 6-8.

FIG. 6 is an example illustration of a processor according to an embodiment. Processor 600 is an example of a type of hardware device that can be used in connection with the implementations above.

Processor 600 may be any type of processor, such as a microprocessor, an embedded processor, a digital signal processor (DSP), a network processor, a multi-core processor, a single core processor, or other device to execute code. Although only one processor 600 is illustrated in FIG. 6, a processing element may alternatively include more than one of processor 600 illustrated in FIG. 6. Processor 600 may be a single-threaded core or, for at least one embodiment, the processor 600 may be multi-threaded in that it may include more than one hardware thread context (or “logical processor”) per core.

FIG. 6 also illustrates a memory 602 coupled to processor 600 in accordance with an embodiment. Memory 602 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 600 can execute any type of instructions associated with algorithms, processes, or operations detailed herein. Generally, processor 600 can transform an element or an article (e.g., data) from one state or thing to another state or thing.

Code 604, which may be one or more instructions to be executed by processor 600, may be stored in memory 602, or may be stored in software, hardware, firmware, or any suitable combination thereof, or in any other internal or external component, device, element, or object where appropriate and based on particular needs. In one example, processor 600 can follow a program sequence of instructions indicated by code 604. Each instruction enters a front-end logic 606 and is processed by one or more decoders 608. The decoder may generate, as its output, a micro operation such as a fixed width micro operation in a predefined format, or may generate other instructions, microinstructions, or control signals that reflect the original code instruction. Front-end logic 606 also includes register renaming logic 610 and scheduling logic 612, which generally allocate resources and queue the operation corresponding to the instruction for execution.

Processor 600 can also include execution logic 614 having a set of execution units 616a, 616b, 616n, etc. Some embodiments may include a number of execution units dedicated to specific functions or sets of functions. Other embodiments may include only one execution unit or one execution unit that can perform a particular function. Execution logic 614 performs the operations specified by code instructions.

After completion of execution of the operations specified by the code instructions, back-end logic 618 can retire the instructions of code 604. In one embodiment, processor 600 allows out of order execution but requires in order retirement of instructions. Retirement logic 620 may take a variety of known forms (e.g., re-order buffers or the like). In this manner, processor 600 is transformed during execution of code 604, at least in terms of the output generated by the decoder, hardware registers and tables utilized by register renaming logic 610, and any registers (not shown) modified by execution logic 614.

Although not shown in FIG. 6, a processing element may include other elements on a chip with processor 600. For example, a processing element may include memory control logic along with processor 600. The processing element may include I/O control logic and/or may include I/O control logic integrated with memory control logic. The processing element may also include one or more caches. In some embodiments, non-volatile memory (such as flash memory or fuses) may also be included on the chip with processor 600.

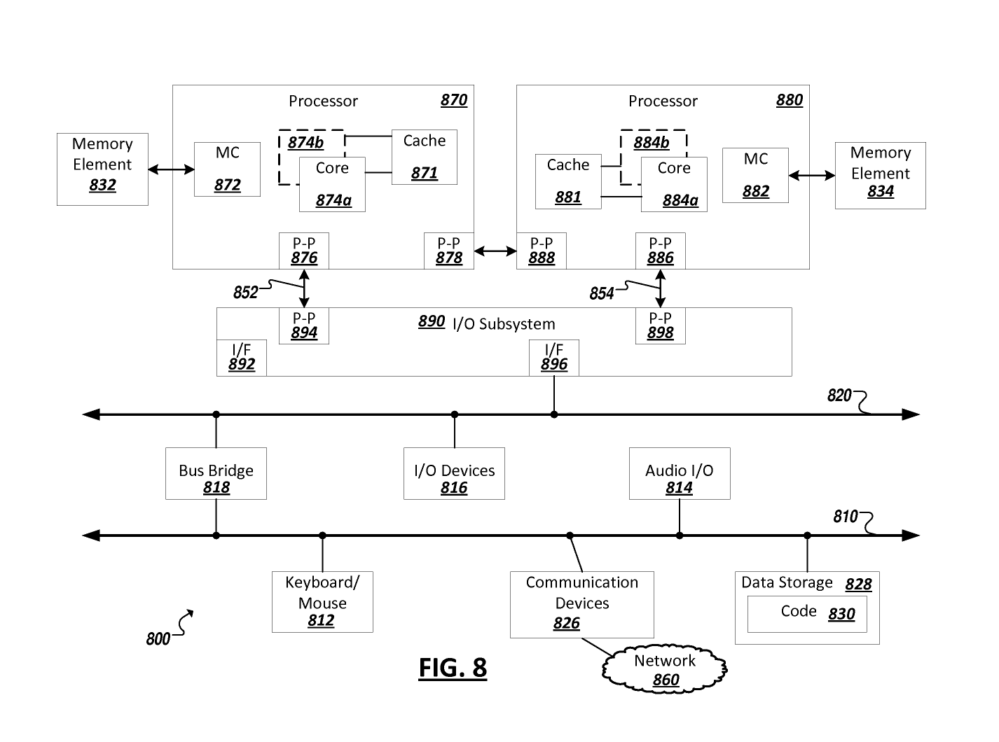

Referring now to FIG. 8, a block diagram is illustrated of an example mobile device 700. Mobile device 700 is an example of a possible computing system (e.g., a host or endpoint device) of the examples and implementations described herein. In an embodiment, mobile device 700 operates as a transmitter and a receiver of wireless communications signals. Specifically, in one example, mobile device 700 may be capable of both transmitting and receiving cellular network voice and data mobile services. Mobile services include such functionality as full Internet access, downloadable and streaming video content, as well as voice telephone communications.

Mobile device 700 may correspond to a conventional wireless or cellular portable telephone, such as a handset that is capable of receiving “3G”, or “third generation” cellular services. In another example, mobile device 700 may be capable of transmitting and receiving “4G” mobile services as well, or any other mobile service.

Examples of devices that can correspond to mobile device 700 include cellular telephone handsets and smartphones, such as those capable of Internet access, email, and instant messaging communications, and portable video receiving and display devices, along with the capability of supporting telephone services. It is contemplated that those skilled in the art having reference to this specification will readily comprehend the nature of modern smartphones and telephone handset devices and systems suitable for implementation of the different aspects of this disclosure as described herein. As such, the architecture of mobile device 700 illustrated in FIG. 8 is presented at a relatively high level. Nevertheless, it is contemplated that modifications and alternatives to this architecture may be made and will be apparent to the reader, such modifications and alternatives contemplated to be within the scope of this description.

In an aspect of this disclosure, mobile device 700 includes a transceiver 702, which is connected to and in communication with an antenna. Transceiver 702 may be a radio frequency transceiver. Also, wireless signals may be transmitted and received via transceiver 702. Transceiver 702 may be constructed, for example, to include analog and digital radio frequency (RF) ‘front end’ functionality, circuitry for converting RF signals to a baseband frequency, via an intermediate frequency (IF) if desired, analog and digital filtering, and other conventional circuitry useful for carrying out wireless communications over modern cellular frequencies, for example, those suited for 3G or 4G communications. Transceiver 702 is connected to a processor 704, which may perform the bulk of the digital signal processing of signals to be communicated and signals received, at the baseband frequency. Processor 704 can provide a graphics interface to a display element 708, for the display of text, graphics, and video to a user, as well as an input element 710 for accepting inputs from users, such as a touchpad, keypad, roller mouse, and other examples. Processor 704 may include an embodiment such as shown and described with reference to processor 600 of FIG. 6.

In an aspect of this disclosure, processor 704 may be a processor that can execute any type of instructions to achieve the functionality and operations as detailed herein. Processor 704 may also be coupled to a memory element 706 for storing information and data used in operations performed using the processor 704. Additional details of an example processor 704 and memory element 706 are subsequently described herein. In an example embodiment, mobile device 700 may be designed with a system-on-a-chip (SoC) architecture, which integrates many or all components of the mobile device into a single chip, in at least some embodiments.

FIG. 8 is a schematic block diagram of a computing system 900 according to an embodiment. In particular, FIG. 8 shows a system where processors, memory, and input/output devices are interconnected by a number of point-to-point interfaces. Generally, one or more of the computing systems described herein may be configured in the same or similar manner as computing system 800.

Processors 870 and 880 may also each include integrated memory controller logic (MC) 872 and 882 to communicate with memory elements 832 and 834. In alternative embodiments, memory controller logic 872 and 882 may be discrete logic separate from processors 870 and 880. Memory elements 832 and/or 834 may store various data to be used by processors 870 and 880 in achieving operations and functionality outlined herein. Processors 870 and 880 may be any type of processor, such as those discussed in connection with other figures. Processors 870 and 880 may exchange data via a point-to-point (PtP) interface 850 using point-to-point interface circuits 878 and 888, respectively. Processors 870 and 880 may each exchange data with a chipset 890 via individual point-to-point interfaces 852 and 854 using point-to-point interface circuits 876, 886, 894, and 898. Chipset 890 may also exchange data with a high-performance graphics circuit 838 via a high-performance graphics interface 839, using an interface circuit 892, which could be a PtP interface circuit. In alternative embodiments, any or all of the PtP links illustrated in FIG. 8 could be implemented as a multi-drop bus rather than a PtP link.

Chipset 890 may be in communication with a bus 820 via an interface circuit 896. Bus 820 may have one or more devices that communicate over it, such as a bus bridge 818 and I/O devices 816. Via a bus 810, bus bridge 818 may be in communication with other devices such as a keyboard/mouse 812 (or other input devices such as a touch screen, trackball, etc.), communication devices 826 (such as modems, network interface devices, or other types of communication devices that may communicate through a computer network 860), audio I/O devices 814, and/or a data storage device 828. Data storage device 828 may store code 830, which may be executed by processors 870 and/or 880. In alternative embodiments, any portions of the bus architectures could be implemented with one or more PtP links.

The computer system depicted in FIG. 8 is a schematic illustration of an embodiment of a computing system that may be utilized to implement various embodiments discussed herein. It will be appreciated that various components of the system depicted in FIG. 8 may be combined in a system-on-a-chip (SoC) architecture or in any other suitable configuration capable of achieving the functionality and features of examples and implementations provided herein.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

Example 1 is a device comprising a biometric input to receive a biometric signal; a biometric signal processor in communication with the biometric input to receive the biometric signal; identify contextual information about the biometric signal; derive contextual biometric information based on the biometric signal and the contextual information; and output contextual biometric information about the biometric signal to a dialog system.

Example 2 may include the subject matter of example 1, further comprising a biometric sensor to receive a biometric input from a user of the biometric sensor.

Example 3 may include the subject matter of example 1 or 2, wherein the biometric input is configured to receive a plurality of biometric signals, and wherein the biometric signal processor is configured to compile the plurality of biometric signals to identify contextual information about the biometric signal.

Example 4 may include the subject matter of example 1 or 2 or 3, further comprising a biometric sensor in communication with the biometric input.

Example 5 may include the subject matter of example 1 or 2 or 3 or 4, further comprising a microphone to receive a speech input to the device.

Example 6 may include the subject matter of example 1 or 2 or 3 or 4 or 5, further comprising a biometric database to store biometric information associated with a user of the device; and wherein the biometric processor is configured to compare the received biometric signal with biometric information stored in the biometric database and with contextual information stored in a contextual database; and derive contextual information about the biometric input.

Example 7 may include the subject matter of example 1 or 2 or 3 or 4 or 5 or 6, further comprising a dialog engine to request contextual information from the user; and provide contextual information to the biometric signal processor.

Example 8 may include the subject matter of example 1 or 2 or 3 or 4 or 5 or 6 or 7, further comprising a signal interface to wirelessly receive the biometric signal from a biometric sensor.

Example 9 may include the subject matter of example 8, wherein the signal interface comprises one or more of a Bluetooth receiver, a Wifi receiver, or a cellular receiver.

Example 10 may include the subject matter of example 8 or 9, further comprising an automatic speech recognition system to receive speech input from the user and covert the speech input into recognizable text, the automatic speech recognition system to provide a textual input to the dialog system.

Example 11 is a method comprising receiving, from a user, a biometric signal from a biometric sensor implemented at least partially in hardware; identifying contextual information associated with a user; identifying contextual biometric information associated with biometric information based on the biometric signal and the contextual information; and providing the contextual biometric information to the user.

Example 12 may include the subject matter of example 11, wherein receiving the biometric signal from the user comprises receiving a plurality of biometric signals from the user and wherein the method further comprises processing the plurality of biometric signals received from the user to identify contextual biometric information.

Example 13 may include the subject matter of example 11 or 12, further comprising requesting contextual information from the user; receiving the contextual information from the user; and processing the biometric signal based on the received contextual information.

Example 14 may include the subject matter of example 11 or 12 or 13, further comprising processing the biometric signal using biometric information stored in a database by the user, the biometric information specific to the user.

Example 15 is a system comprising a biometric signal processor comprising a biometric input to receive a biometric signal from a user; a biometric processor in communication with the biometric input to receive the biometric signal; identify contextual information associated with the biometric signal; and derive contextual biometric information based on the biometric signal. The system also includes a dialog system to output a dialog message to the user, the dialog message associated with the contextual biometric information.

Example 16 may include the subject matter of example 15, wherein the biometric signal processor is configured to identify context information for the user and/or the biometric signal and derive contextual biometric information based on the identified contextual information.

Example 17 may include the subject matter of example 15 or 16, wherein the dialog system is configured to request contextual information from the user; receive the user-provided contextual information; and provide the user-provided contextual information to the biometric signal processor; and wherein the biometric signal processor processes the biometric signal based on the user-provided contextual information to derive contextual biometric information.

Example 18 may include the subject matter of example 15 or 16 or 17, further comprising a biometric sensor in communication with the biometric input.

Example 19 may include the subject matter of example 15 or 16 or 17 or 18, further comprising a microphone to receive speech input from the user.

Example 20 may include the subject matter of example 15 or 16 or 17 or 18 or 19, further comprising a biometric database to store biometric information associated with a user of the adaptive ASR device; and wherein the biometric processor is configured to compare the received biometric signal with a biometric information stored in the biometric database; and derive contextual biometric information based on the comparison.

Example 21 may include the subject matter of example 15 or 16 or 17 or 18 or 19 or 20, further comprising a signal interface to wirelessly receive the biometric signal from a biometric sensor.

Example 22 may include the subject matter of example 15 or 16 or 17 or 18 or 19 or 20 or 21, wherein the signal interface comprises one or more of a Bluetooth receiver, a Wifi receiver, or a cellular receiver.

Example 23 may include the subject matter of example 1, wherein deriving contextual biometric information comprises extracting a biometric signal type from the biometric signal; extracting a biometric signal value for the biometric signal type; identifying contextual data for the biometric signal type and for the biometric signal value; identifying contextual data for a user of the device; and interpreting the biometric signal based on the contextual data for the biometric signal type, the biometric signal value, and the contextual data for the user.

Example 24 may include the subject matter of example 12, wherein deriving contextual biometric information comprises extracting a biometric signal type from the biometric signal; extracting a biometric signal value for the biometric signal type; identifying contextual data for the biometric signal type and for the biometric signal value; identifying contextual data for a user of the device; and interpreting the biometric signal based on the contextual data for the biometric signal type, the biometric signal value, and the contextual data for the user.

Example 25 may include the subject matter of example 17, wherein deriving contextual biometric information comprises extracting a biometric signal type from the biometric signal; extracting a biometric signal value for the biometric signal type; identifying contextual data for the biometric signal type and for the biometric signal value; identifying contextual data for a user of the device; and interpreting the biometric signal based on the contextual data for the biometric signal type, the biometric signal value, and the contextual data for the user.

While this specification contains many specific implementation details, these should not be construed as limitations on the scope of any disclosures or of what may be claimed, but rather as descriptions of features specific to particular embodiments of particular disclosures. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

1. A device comprising:
a biometric input to receive a biometric signal;
a biometric signal processor in communication with the biometric input to:
receive the biometric signal;
identify contextual data associated with the biometric signal;
derive contextual biometric information based on the biometric signal and the contextual data, the contextual biometric information comprising an interpretation of the biometric signal; and
output contextual biometric information about the biometric signal to a dialog system.

2. The device of claim 1, further comprising a biometric sensor to receive a biometric input from a user of the biometric sensor.

3. The device of claim 1, wherein the biometric input is configured to receive a plurality of biometric signals, and wherein the biometric signal processor is configured to compile the plurality of biometric signals to identify contextual information about the biometric signal.

4. The device of claim 1, further comprising a biometric sensor in communication with the biometric input.

5. The device of claim 1, further comprising a microphone to receive a speech input to the device.

6. The device of claim 1, further comprising a biometric database to store biometric information associated with a user of the device; and
wherein the biometric signal processor is configured to:
compare the biometric signal with biometric information stored in the biometric database and with contextual data stored in a contextual database; and
derive contextual biometric information about the biometric input.

7. The device of claim 1, further comprising a dialog engine to:
request contextual data from a user; and
provide contextual data to the biometric signal processor.

8. The device of claim 1, further comprising a signal interface to wirelessly receive the biometric signal from a biometric sensor.

9. The device of claim 8, wherein the signal interface comprises one or more of a Bluetooth receiver, a Wifi receiver, or a cellular receiver.

10. The device of claim 1, further comprising an automatic speech recognition system to receive speech input from a user and covert the speech input into recognizable text, the automatic speech recognition system to provide a textual input to the dialog system.

11. The device of claim 1, wherein deriving contextual biometric information based on the biometric signal and the contextual data comprises:
extracting a biometric signal type from the biometric signal;
extracting a biometric signal value for the biometric signal type;
identifying contextual data for the biometric signal type and for the biometric signal value;
identifying contextual data for a user of the device; and
interpreting the biometric signal based on the contextual data for the biometric signal type, the biometric signal value, and the contextual data for the user.

12. A method comprising:
receiving, from a user, a biometric signal from a biometric sensor implemented at least partially in hardware;
identifying contextual data associated with one or both of the biometric signal or the user;
deriving contextual biometric information associated with biometric information based on the biometric signal and the contextual data; and
providing the contextual biometric information to the user.

13. The method of claim 12, wherein receiving the biometric signal from the user comprises receiving a plurality of biometric signals from the user and wherein the method further comprises processing the plurality of biometric signals received from the user to derive the contextual biometric information.

14. The method of claim 12, further comprising:
requesting contextual data from the user;
receiving the contextual data from the user; and
processing the biometric signal based on the received contextual data.

15. The method of claim 12, further comprising processing the biometric signal using biometric information stored in a database by the user, the biometric information specific to the user.

16. The method of claim 12, wherein deriving contextual biometric information comprises:
extracting a biometric signal type from the biometric signal;
extracting a biometric signal value for the biometric signal type;
identifying contextual data for the biometric signal type and for the biometric signal value;
identifying contextual data for the user; and
interpreting the biometric signal based on the contextual data for the biometric signal type, the biometric signal value, and the contextual data for the user.

17. A system comprising:
a biometric signal processor comprising:
a biometric input to receive a biometric signal from a user;
a biometric processor in communication with the biometric input to:
receive the biometric signal;
identify contextual data associated with the biometric signal; and
derive contextual biometric information based on the biometric signal, the contextual biometric information comprising an interpretation of the biometric signal; and
a dialog system to output a dialog message to the user, the dialog message associated with the contextual biometric information.

18. The system of claim 17, wherein the biometric signal processor is configured to identify context information for one or both of the user or the biometric signal and derive contextual biometric information based on the identified contextual data.

19. The system of claim 17, wherein the dialog system is configured to request user-provided contextual data from the user; receive the user-provided contextual data; and provide the user-provided contextual data to the biometric signal processor; and wherein
the biometric signal processor processes the biometric signal based on the user-provided contextual data to derive contextual biometric information.

20. The system of claim 17, further comprising a biometric sensor in communication with the biometric input.

21. The system of claim 17, further comprising a microphone to receive speech input from the user.

22. The system of claim 17, further comprising a biometric database to store biometric information associated with the user; and
wherein the biometric processor is configured to:
compare the biometric signal with a biometric information stored in the biometric database; and
derive contextual biometric information based on the comparison.

23. The system of claim 17, further comprising a signal interface to wirelessly receive the biometric signal from a biometric sensor.

24. The system of claim 23, wherein the signal interface comprises one or more of a Bluetooth receiver, a Wifi receiver, or a cellular receiver.

25. The system of claim 17, wherein deriving contextual biometric information comprises:
extracting a biometric signal type from the biometric signal;
extracting a biometric signal value for the biometric signal type;
identifying contextual data for the biometric signal type and for the biometric signal value;
identifying contextual data for user; and
interpreting the biometric signal based on the contextual data for the biometric signal type, the biometric signal value, and the contextual data for the user.
